(19) United States
(12) Patent Application Publication
(10) Pub. No.: US 2007/0096908 A1
(43) Pub. Date: May 3, 2007

(54) RFID method for guiding visually handicapped

(75) Inventors: Chun-I Chu, Zhudong Town (TW); Pao-Cheng Hsiao, Taipei City (TW); Chien-Pin Lee, Luzhu Shiang (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 11/304,736

(22) Filed: Dec. 16, 2005

(30) Foreign Application Priority Data
Nov. 3, 2005 (TW) 094138554

(51) Int. Cl. G08B 13/14; G01S 1/00; G08B 1/08; G09B 21/00

(52) U.S. Cl. 340/572.1; 340/539.13; 340/825.19; 342/385

(57) ABSTRACT

The present invention relates to a method for guiding visually handicapped by the use of radio frequency identification (RFID) technology, which is able to issue an audio signal to assist and guide the movement of a visually handicapped person as an direction is being interrogated and obtained from guiding bricks embedded with RFID tags of various identification codes. The method comprises the step of: defining a plurality of identification codes, each being distinct from one another and to be stored respectively in different RFID tag; defining a plurality of directions of guidance, each being corresponding to a combination of a specific amount of the defined identification codes; forming a preceding record by recording a previous interrogation of RFID tags; interrogating RFID tags embedded in guiding bricks for forming a current data thereby; combining the current data with the preceding record so as to select a direction out of the plural previously defined directions accordingly.

### FIELD OF THE INVENTION

The present invention relates to a guiding mechanism for visually handicapped persons, and more particularly, to a method for guiding visually handicapped persons by the use of radio frequency identification (RFID) technology, capable of issuing an audio signal to assist and guide the movement of a visually handicapped person as an direction is being interrogated and obtained from guiding bricks embedded with RFID tags of various identification codes.

### BACKGROUND OF THE INVENTION

The nature sense of touch is the primary means available to visually impaired individual for enabling the same to move about and act in his/her daily life. In most cases, a visually handicapped person can only read from books of Braille system, that is a system of touch reading and writing in which raised dots represent the letters of the alphabet, and can orientate himself and establish his exact location by touching and recognizing guiding patterns embossed on guiding bricks through the help of a guiding stick. Nevertheless, the conventional touch recognition is disadvantageous as following:
(1)The area available on a guiding brick limits the amount of patterns to be embossed thereon, and thus limits the amount of information available to be identified by a visually impaired individual.
(2) For enabling a visually impaired individual to familiarize and master any kind of touch recognition, time and practice are essential, moreover, the situation can be worse if there are plenty of patterns to be identified by touch and occasionally there are new pattern to be added in the list of identification to be memorized.
(3) It is possible for a visually impaired individual to misidentify a pattern, that can be a potential cause of unnecessary damager.
(4) Sometimes, a visually impaired individual may have difficult to identify an embossed pattern since it is covered by foreign objects.

In view of the above description, many devices currently exist for providing predetermined audio messages for aiding ambulatory travel of blind persons. One of which is the auxiliary guiding device for visually impaired persons disclosed in Taiwan Pat. No. 1228410, by which an audio signal pre-recorded in an RFID tag embedded in a guiding brick can be issued to assist the movement of a visually handicapped person as the sensor arranged at the tip of the guiding stick of the blind person has access to the RFID tag. However, none of which can provide directional guidance capable of guiding a visually impaired person to walk in his/her preferred direction in quick response.

To sum up, it is in great need to have an RFID method for guiding visually handicapped which can assist the movement of a blind person actively by reducing the time required for identifying direction and thus shorten the traveling time for the blind person to reach his/her destination.

### SUMMARY OF THE INVENTION

It is the primary object of the present invention to provide an RFID method for guiding a visually handicapped person, that is capable of issuing an audio signal to assist and guide the movement of the visually handicapped person as an direction is obtained by combining specific identification codes, each being defined and stored in an RFID tag embedded in a guiding brick while each being used to specify a motion to be taken by the visually handicapped person.

To achieve the above object, the present invention provides an RFID method for guiding a visually handicapped person, that can assist the movement of the visually handicapped person by audio signals obtained from combining the interrogations of various RFID tags embedded in different guiding bricks, and the RFID method comprises steps of:
defining a plurality types of identification code, each type being distinct from one another and to be stored respectively in different RFID tag;
defining a plurality of directions of guidance, each being corresponding to a combination of a specific amount of the identification codes;
forming a preceding record by recording a previous interrogation of RFID tags, being respectively embedded in a guiding brick;
interrogating RFID tags respectively embedded in a guiding brick for forming a current data thereby; and
combining the current data with the preceding record so as to form a direction of guidance to be selected out of the plural previously defined directions of guidance accordingly.

Preferably, the RFID method of the present invention further comprises the step of: making an evaluation to determining whether the current data is the repeat of the preceding record.

Preferably, each type of identification code is used to specify a motion to be taken by the visually handicapped person, whereas the motion can be a motion selected from the group consisting of turn, move forward, left turn ahead, right turn ahead, stop, crossroad, stair ahead, and stair-climbing start, and so on.

Preferably, the direction of guidance formed by the combination of various identification codes is selected from the group consisting of going straight forward, turning left, turning right, alerting to stop going forward, alerting to cross-road ahead and climbing stair, and so on.

Preferably, the RFID method of the present invention further comprises the step of: issuing an audio signal corresponding to the formed direction of guidance for assisting the movement of the visually handicapped person.

Preferably, the RFID method of the present invention further comprises the step of: issuing a signal of vibration corresponding to the formed direction of guidance for assisting the movement of the visually handicapped person.

Preferably, the RFID method of the present invention further comprises the step of: issuing an alert as the method is failing to form a direction of guidance.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a sectional view of an RFID method for guiding a visually handicapped person according to a preferred embodiment of the present invention.

FIG. 2 is a flowchart of an RFID method for guiding a visually handicapped person according to a preferred embodiment of the present invention; whereas the upper section of the preferred embodiment is shown in FIG. 2A while the lower section of the preferred embodiment is shown in FIG. 2B.

FIG. 3A is a table showing the indication of identification code according to the present invention.

FIG. 3B is a table showing relation between the directions of guidance and the combination of various identification codes according to the present invention.

FIG. 4A is a schematic diagram illustrating a direction of left/right turn ahead formed by the combination of various identification codes stored in different RFID tags according to the present invention.

FIG. 4B is a schematic diagram illustrating a direction of stop going forward formed by the combination of various identification codes stored in different RFID tags according to the present invention.

FIG. 4C is a schematic diagram illustrating a direction of alerting to intersection ahead formed by the combination of various identification codes stored in different RFID tags according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

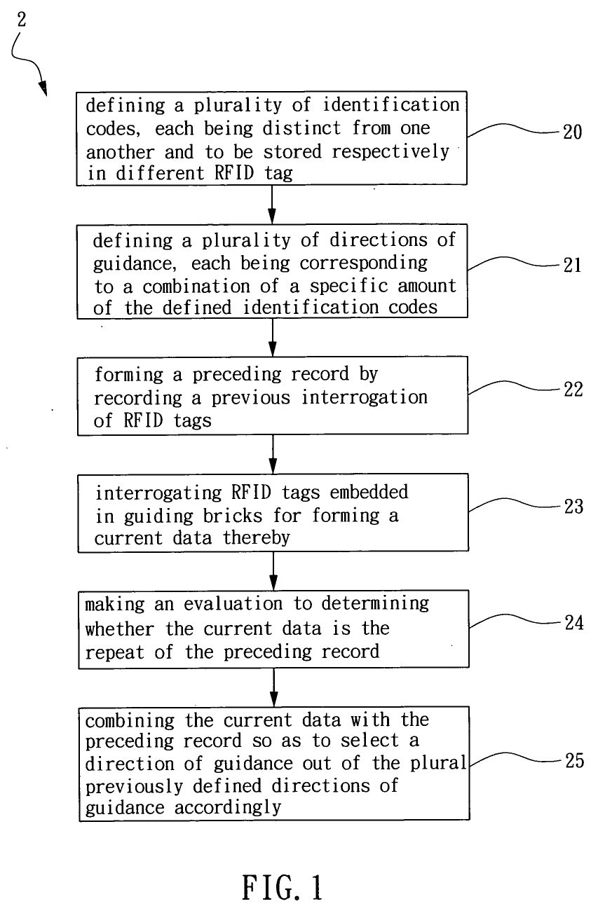

Please refer to FIG. 1, which is a sectional view of an RFID method for guiding a visually handicapped person according to a preferred embodiment of the present invention. In the RFID method of this preferred embodiment, first, a plurality types of identification code are defined and stored in different RFID tag in respective, and then a number of RFID tags, each storing one identification code of a certain type selected form the above defined types of identification code, are being embedded in guiding bricks in respective, i.e. the guiding bricks in this embodiment can be classified according to the type of identification code stored in the RFID tag embedded therein. By aligning the RFID-embedded guiding bricks along the moving path designed for aiding the movement of visually impaired persons, any visually impaired person with access to a corresponding RFID reader is able to interrogate the identification codes store in the RFID tags embedded in guiding bricks and then obtain directions of guidance. In this preferred embodiment, the RFID reader is arranged on the guiding stick, however, the arrangement of the RFID tag is not limited thereby.

Yet, the RFID method of this preferred embodiment comprises the steps of:
step 20: defining a plurality types of identification code, each being distinct from one another and to be stored respectively in different RFID tag;
step 21: defining a plurality of directions of guidance, each being corresponding to a combination of a specific amount of the identification codes;
step 22: forming a preceding record by recording a previous interrogation of RFID tags, being respectively embedded in a guiding brick;
step 23: interrogating RFID tags respectively embedded in a guiding brick for forming a current data thereby;
step 24: making an evaluation to determining whether the current data is the repeat of the preceding record; and
step 25: combining the current data with the preceding record so as to form a direction of guidance to be selected out of the plural previously defined directions of guidance accordingly; wherein, a vibration or an audio signal corresponding to the formed direction of guidance can be issued for assisting the movement of the visually handicapped person.

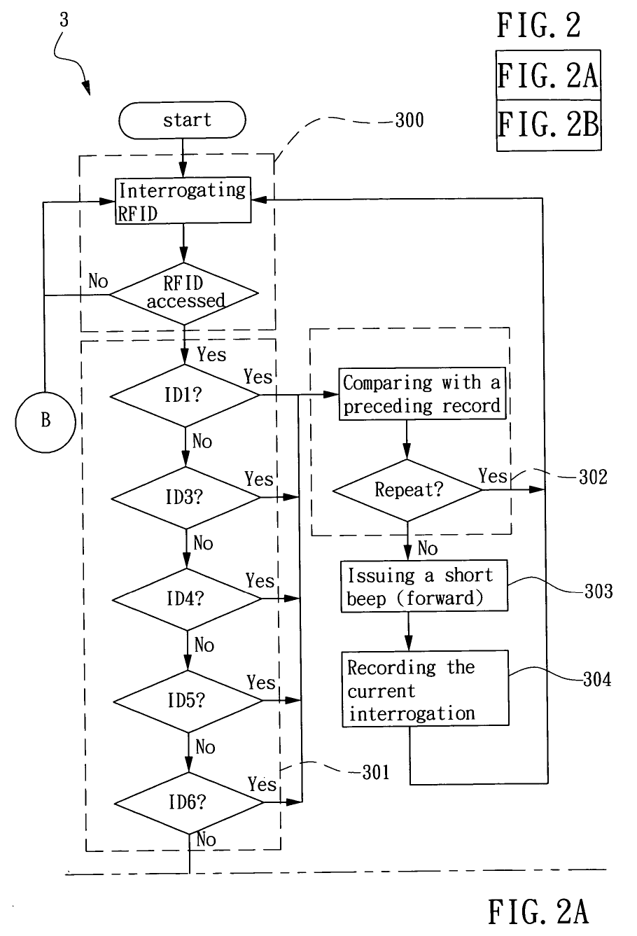

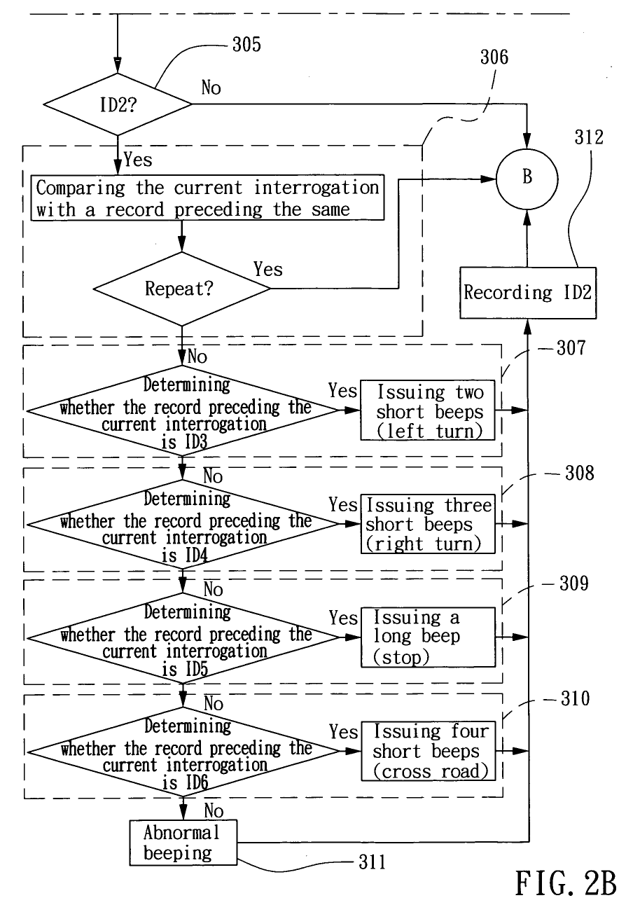

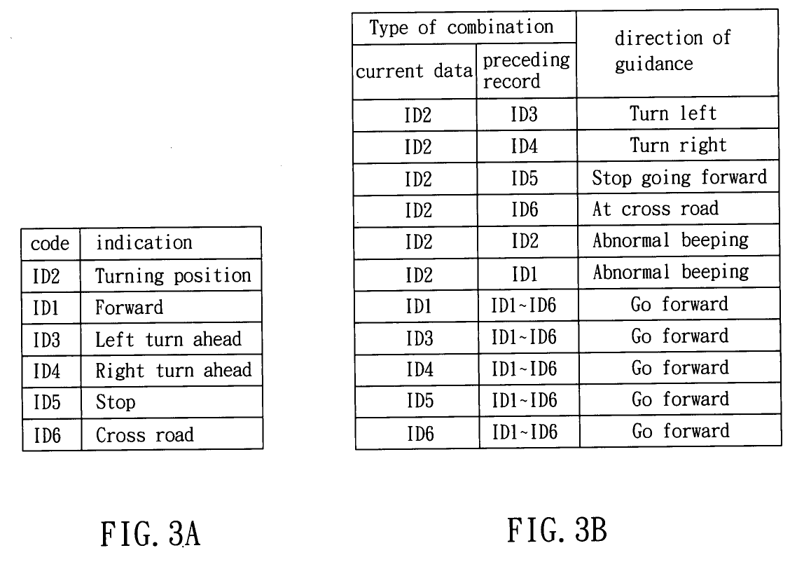

Please refer to FIG. 2, which is a flowchart of an RFID method for guiding a visually handicapped person according to a preferred embodiment of the present invention. It is noted that this embodiment is suitable to be applied in flat surface. In this preferred embodiment, there are six types of identification code, referred as ID1˜ID6 in respectively and each being specified to a motion as shown in the table of FIG. 3A. Furthermore, the directions of guidance, each corresponding to a combination of a specific amount of the identification codes, are illustrated in the table of FIG. 3B. The motions and the directions of guidance shown in FIG. 3A and FIG. 3B are just for illustration and thus are not limited thereby.

In the upper section of the preferred embodiment shown in FIG. 2A, the guidance illustrated in the flowchart 3 starts as a visually handicapped person starts to use a guiding stick have an RFID reader attached thereon for guiding himself to move forward, and then the flow proceeds to step 300. In step 300, the RFID reader is enabled to interrogate an RFID tag embedded in a guiding brick for obtaining an identification code stored therein, and then an evaluation is made to determine whether the identification codes had been accessed by the interrogation; if so, the flow proceeds to step 301; otherwise, the flow proceeds to step B. In step 301, a procedure is perform to determine whether the access identification code is a type of identification code selected from ID1, ID3, ID4, ID5, and ID6; if so, the flow proceeds to step 302; otherwise, the flow proceeds to step 305 shown in FIG. 2B. In step 302, the current interrogation is compared with a preceding record to determine whether the current interrogation is the repeat of the preceding record, and if so, the flow proceeds to step 300; otherwise, the flow proceeds to step 303. In step 303, a short beep is issued to inform the visually handicapped person to keep moving forward, and then the flow proceeds to step 304. In step 304, the current interrogation is recorded and then the flow proceeds back to step 300.

In the lower section of the preferred embodiment shown in FIG. 2B, an evaluation is being made to determine whether the accessed identification code is ID2 while it has been determined to be none of the group consisting of ID1, ID3, ID4, ID5, and ID6; if so, the flow proceeds to step 306; otherwise, the flow proceeds to step B. In step 306, the current interrogation is compared with a preceding record to determine whether the current interrogation is the repeat of the preceding record, and if so, the flow proceeds to step B; otherwise, the flow proceeds to step 307. In step 307, an evaluation is being made to determine whether the preceding record is ID3; if so, two short beeps will be issued and then the flow proceeds to step 312; otherwise, the flow proceeds to step 308. In step 308, an evaluation is being made to determine whether the preceding record is ID4; if so, three short beeps will be issued and then the flow proceeds to step 312; otherwise, the flow proceeds to step 309. In step 309, an evaluation is being made to determine whether the preceding record is ID5; if so, one long beep will be issued and then the flow proceeds to step 312; otherwise, the flow proceeds to step 310. In step 310, an evaluation is being made to determine whether the preceding record is ID6; if so, four short beeps will be issued and then the flow proceeds to step 312; otherwise, abnormal beeping is issued, and then the flow proceeds to step 312. In step 312, the current interrogation of ID2 is recorded and then the flow proceeds back to step B.

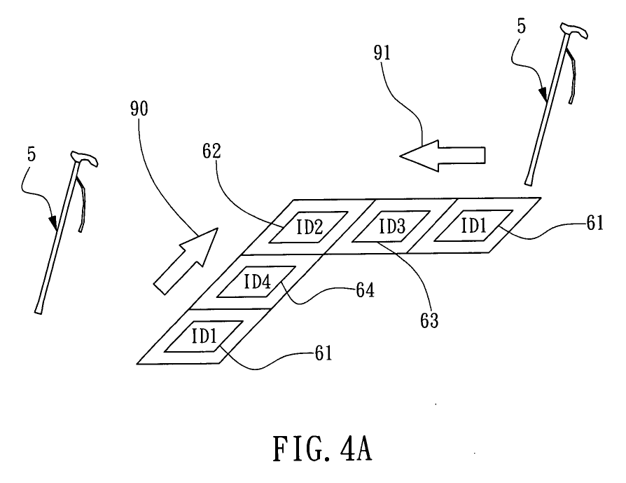

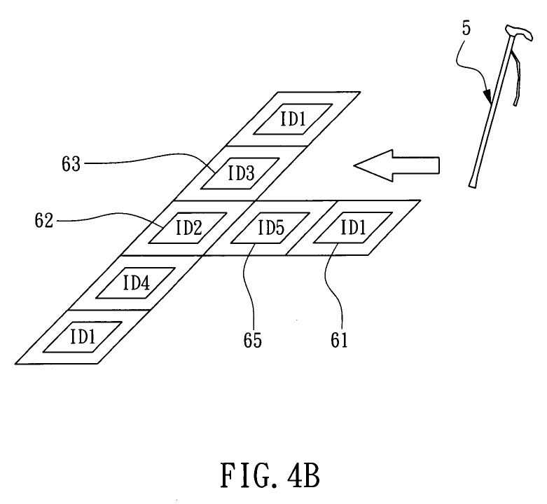

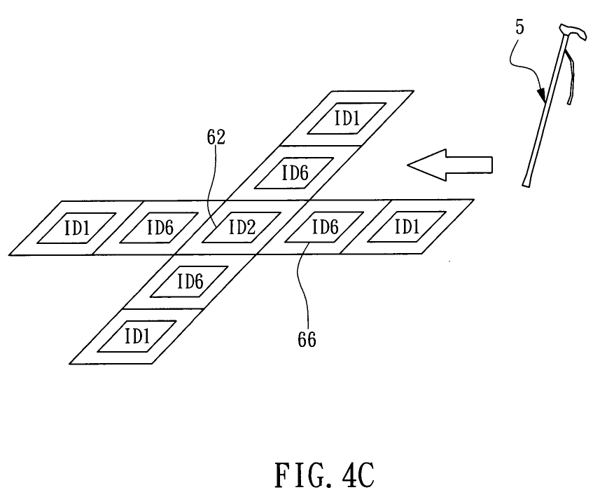

Please refer to FIG. 4A, which is a schematic diagram illustrating a direction of left/right turn ahead formed by the combination of various identification codes stored in different RFID tags according to the present invention. In FIG. 4A, a left turn is specified by the formation of five guiding brick of three classes o 61, 62, 63, as a visually impaired person represented by the guiding stick 5 is moving along the direction 91, and a right turn is specified by the formation of five guiding brick of three classes o 61, 62, 63, 64, featuring by ID1, ID3, ID3, and ID4, as a visually impaired person represented by the guiding stick 5 is moving along the direction 90. Since a turn is present in FIG. 4A while the turning direction is dependent on the moving direction of the visually impaired person 5, there are a brick of class 62, a brick of class 64 and a brick of class 61 are place successively alone the moving path of direction 90 with the brick of class 62 to be placed at the exact turning position for guiding the visually impaired person to turn right at the exact turning position, and there are the brick of class 62, a brick of class 63 and a brick of class 61 are place successively alone the moving path of direction 91 with the brick of class 62 to be placed at the exact turning position for guiding the visually impaired person to turn left at the exact turning position.

When the visually impaired person is moving along the direction 90, the brick of class 61 is first being interrogated by the guiding stick 5, and then the brick of class 64 is being interrogated and thus the visually impaired person is guided to move forward as that defined in the steps 301˜304 of the FIG. 2A, thereafter, as soon as the brick of class 62 is being interrogated, three short beeps are issued to guide the visually impaired person to turn right as that defined in the steps 305˜308 of the FIG. 2B. When the visually impaired person is moving along the direction 91, the brick of class 61 is first being interrogated by the guiding stick 5, and then the brick of class 63 is being interrogated and thus the visually impaired person is guided to move forward as that defined in the steps 301˜304 of the FIG. 2A, thereafter, as soon as the brick of class 62 is being interrogated, two short beeps are issued to guide the visually impaired person to turn left as that defined in the steps 305˜308 of the FIG. 2B. It is noted that the audio signal of beeping can be specified at will, and thus is not limited by the three/two short beeps of this embodiment.

Please refer to FIG. 4B, which is a schematic diagram illustrating a direction of stop going forward formed by the combination of various identification codes stored in different RFID tags according to the present invention. In FIG. 4B, the visually impaired person is moving toward a dead end and has to turn either right or left. Therefore, as the visually impaired person is moving toward the dead end along the direction defined by the arrow sign, it is required to place a brick of class 62 right at the dead end with a brick of class 65 featuring ID5 to be placed in front of the same while having other relating bricks to be placed as those shown in FIG. 4A. The identification code of ID5 indicates that there is going to be a dead end ahead while it is accessible to turn either to the right or to the left. Since the left/right turn is guided by the bricks formed as those shown in FIG. 4A and thus is not described further herein. However, when the visually impaired person is moving along the direction defined by the arrow and thus toward the dead end, the brick of class 61 is first being interrogated by the guiding stick 5, and then the brick of class 65 is being interrogated and thus the visually impaired person is informed of a dead end ahead, thereafter, as soon as the brick of class 62 is being interrogated, one long beep is issued since it matches with the condition of the interrogation of an ID5 following by the interrogation of an ID2 as that define in step 309 of FIG. 2B, and thus the visually impaired person must stop to turn right or left at will. If the visually impaired person decide to turn right, the brick of class 63 will be interrogated and thus the guidance will follow the procedure as that defined in the steps 301˜304 of the FIG. 2A.

Please refer to FIG. 4C, which is a schematic diagram illustrating a direction of alerting to intersection ahead formed by the combination of various identification codes stored in different RFID tags according to the present invention. In FIG. 4C, the visually impaired person is moving toward an intersection and can choose to go straight forward, to turn right or to turn left. Therefore, as the visually impaired person is moving toward the intersection along the direction defined by the arrow sign, it is required to place a brick of class 62 right at the intersection with four bricks of class 66 featuring ID6 to be placed surrounding the same while each having a brick of class 61 to be placed adjacent thereto as shown in FIG. 4A. The identification code of ID6 indicates that there is going to be an intersection ahead while it is accessible to go straight forward, to turn right or to turn left. When the visually impaired person is moving along the direction defined by the arrow and thus toward the intersection, the brick of class 61 is first being interrogated by the guiding stick 5, and then the brick of class 66 is being interrogated and thus the visually impaired person is informed of an intersection ahead, thereafter, as soon as the brick of class 62 is being interrogated, four short beeps are issued since it matches with the condition of the interrogation of an ID6 following by the interrogation of an ID2 as that define in step 310 of FIG. 2B, and thus the visually impaired person can choose to go straight forward, to turn right or to turn left at will. Moreover, if a brick of class 62 is detected during a guidance and that can not match any of the conditions defined in the steps of 307 tp 310 of FIG. 2B, an abnormal beeping will be issued as that defined in step 311 of FIG. 2B.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An RFID method for guiding a visually handicapped person, capable of assisting the movement of the visually handicapped person by the use of RFID tags embedded in guiding bricks, the method comprising steps of:
defining a plurality types of identification code, each being distinct from one another and to be stored respectively in different RFID tag;
defining a plurality of directions of guidance, each being corresponding to a combination of a specific amount of the identification codes;
forming a preceding record by recording a previous interrogation of RFID tags, being respectively embedded in a guiding brick;
interrogating RFID tags respectively embedded in a guiding brick for forming a current data thereby; and
combining the current data with the preceding record so as to form a direction of guidance to be selected out of the plural previously defined directions of guidance accordingly.

2. The method of claim 1, further comprising:
making an evaluation to determining whether the current data is the repeat of the preceding record.

3. The method of claim 1, wherein one type of the plural types of identification code is used to specify a turn.

4. The method of claim 1, wherein one type of the plural types of identification code is used to specify a motion of move forward.

5. The method of claim 1, wherein one type of the plural types of identification code is used to specify a motion of right turn ahead.

6. The method of claim 1, wherein one type of the plural types of identification code is used to specify a motion of left turn ahead.

7. The method of claim 1, wherein one type of the plural types of identification code is used to specify a motion of stop.

8. The method of claim 1, wherein one type of the plural types of identification code is used to specify an intersection.

9. The method of claim 1, wherein one type of the plural types of identification code is used to specify a stair.

10. The method of claim 1, wherein one type of the plural types of identification code is used to specify a motion of stair ahead.

11. The method of claim 1, wherein one of the plural directions of guidance formed by the combination of various identification codes is to go straight ahead.

12. The method of claim 1, wherein one of the plural directions of guidance formed by the combination of various identification codes is to turn left.

13. The method of claim 1, wherein one of the plural directions of guidance formed by the combination of various identification codes is to turn right.

14. The method of claim 1, wherein one of the plural directions of guidance formed by the combination of various identification codes is to stop going forward.

15. The method of claim 1, wherein one of the plural directions of guidance formed by the combination of various identification codes is to alert an intersection ahead.

16. The method of claim 1, wherein one of the plural directions of guidance formed by the combination of various identification codes is to climb a stair.

17. The method of claim 1, further comprising:
issuing an audio signal corresponding to the formed direction of guidance for assisting the movement of the visually handicapped person.

18. The method of claim 1, further comprising:
issuing a signal of vibration corresponding to the formed direction of guidance for assisting the movement of the visually handicapped person.

19. The method of claim 1, further comprising:
issuing an alert as the method is failing to form a direction of guidance.

20. An RFID method for guiding a visually handicapped person, capable of assisting the movement of the visually handicapped person by the use of RFID tags embedded in guiding bricks, the method comprising steps of:
defining a plurality types of identification code, each type being distinct from one another and to be stored respectively in different RFID tag;
defining a plurality of directions of guidance, each being corresponding to a combination of a specific amount of the defined identification codes;
forming a preceding record by recording a previous interrogation of RFID tags, being respectively embedded in a guiding brick;
interrogating RFID tags respectively embedded in a guiding brick for forming a current data thereby; and
combining the current data with the preceding record so as to form a direction of guidance to be selected out of the plural previously defined directions of guidance accordingly;
wherein, each type of identification code is used to specify a motion to be taken by the visually handicapped person, whereas the motion can be a motion selected from the group consisting of turn, move forward, left turn ahead, right turn ahead, stop, crossroad, stair ahead, and stair-climbing start, and so on; and the direction of guidance formed with respect to the combination of various identification codes is a direction of guidance selected from the group consisting of going straight forward, turning left, turning right, alerting to stop going forward, alerting to cross-road ahead and climbing stair, and so on.
